(19) United States
(12) Patent Application Publication
(10) Pub. No.: US 2012/0192443 A1
(43) Pub. Date: Aug. 2, 2012

(54) SQUARE ROOT 1-2-3

(76) Inventor: Steven E. Lucero, Isleta, NM (US)

(21) Appl. No.: 13/017,698

(22) Filed: Jan. 31, 2011

(51) Int. Cl. B43L 7/027

(52) U.S. Cl. 33/429

(57) ABSTRACT

A framing square may be used with wood or metal framing material. The framing square may be designed to exactly fit the size of the framing material, so as not to overhand off a side of the framing material. The framing square may, for example, allow for use when laying out door and window openings when the frame is laying down.

### BACKGROUND OF THE INVENTION

The present invention relates to framing squares and, more particularly, to framing square adapted to fit a 2 by 4 or a 2 by 6 wood or metal framing material.

In some cases, a larger, conventional framing tool cannot be used. For example, when laying out door and window openings, conventional framing tools may not work when the frame is laying down.

As can be seen, there is a need for a framing square that may fit framing material exactly to size, without the need to overhang the material.

### SUMMARY OF THE INVENTION

In one aspect of the present invention, a tool comprises a triangular piece having a first side forming a right angle with a second side; an alignment edge protruding orthogonally from the second side of the triangular piece, wherein the first side and the second side have a length of 3.5 inches.

In another aspect of the present invention, a tool comprises a triangular piece having a first side forming a right angle with a second side; an alignment edge protruding orthogonally from the second side of the triangular piece, wherein the first side and the second side have a length of 3.5 inches.

In a further aspect of the present invention, a tool comprises a triangular piece having a first side forming a right angle with a second side; an alignment edge protruding orthogonally from the second side of the triangular piece, wherein the first side and the second side have a length of 3.5 inches.

These and other features, aspects and advantages of the present invention will become better understood with reference to the following drawings, description and claims.

### BRIEF DESCRIPTION OF THE DRAWINGS

FIG. 1 is a perspective view of a framing square according to an exemplary embodiment of the present invention;

FIG. 2 is a side view of the framing square of FIG. 1;

FIG. 3 is a side view of a framing square according to another embodiment of the present invention; and

FIG. 4 is a chart describing exemplary dimensions of the framing squares shown in FIGS. 2 and 3.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a framing square that may be used with wood or metal framing material. The framing square may be designed to exactly fit the size of the framing material, so as not to overhand off a side of the framing material. The framing square may, for example, allow for use when laying out door and window openings when the frame is laying down.

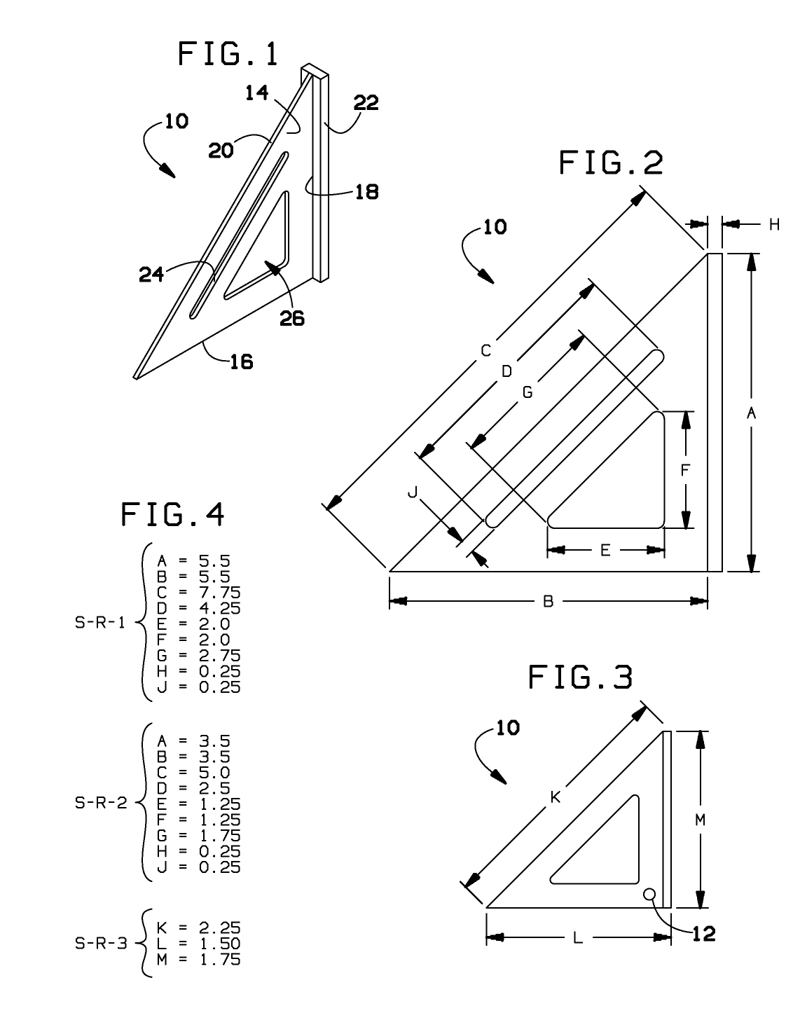

Referring to FIGS. 1 and 2, a framing square 10 may include a triangular portion 14. The triangular portion 14 may be a flat member having a first side 16, a second side 18 and a hypotenuse 20. The first side 16 may form a right angle with the second side 18. The first side 16 may include a framing alignment member 22 disposed orthogonally to the plane of the triangular portion 14. The framing alignment member 22 may allow the framing square 10 to be aligned along one edge of a framing member (not shown). The length of the second side 18 (labeled in FIG. 2 as length B and labeled in FIG. 3 as length L) may be the same length as the framing member. For example, if the framing member is wood 2 by 4 lumber, the length B may be 3.5 inches. If the framing member is wood 2 by 6 lumber, the length B may be 5.5 inches. In any event, the length B may be dimensioned to fit the lumber being used, preventing overhang and allowing the framing square 10 to be used in tight spaces where conventional rafter angle squares, tri-squares, and the like may not be used.

The framing square 10 may include a slot 24 cut therein for measuring angles and determining the rise over a 12 inch run for hip or valley rafters. The framing square 10 may also include a triangular cut out 26 in the triangular portion 14. The triangular cut out 26 may have sides parallel with the first side 16, the second side 18 and the hypotenuse 20.

Referring to FIG. 3, the framing square 10 may be designed, for example, to fit the edge of framing material. In this embodiment, the length L of the edge may be 1.5 inches. In some embodiments, the framing square 10 may include a hole 12 in a portion thereof. The hole 12 may permit convenient attachment of the framing square 10 to a tool or allow use of the framing square 10 as a decorative key chain.

Referring to FIG. 4, exemplary dimensions of the framing square 10 of FIGS. 2 and 3 are shown. S-R-1 dimensions describe one embodiment of the present invention, where the framing square 10 is dimensioned for 2 by 6 framing material. S-R-2 dimensions describe one embodiment of the present invention, wherein the framing square 10 is dimensioned for 2 by 4 framing material. S-R-3 describes one embodiment of the present invention, wherein the framing square 10 is dimensioned for the side of 2 by X framing material.

The framing square 10 may include one or more magnets (not shown) or may be made of magnetic material. In this embodiment, the framing square 10 may be attached to metal framing members without the need to hold the framing square in place.

The present invention may further include a method for marking framing material for cutting. The method may including laying the framing material down on one side thereof, aligning the alignment member 22 of the framing square 10 along the another side of the framing material, and marking a line along an edge of the framing square 10, wherein the alignment member 22 lies flat along the side of the framing material when in place on the framing material. In other words, the user is not required to life the framing material from a surface to use the framing square to mark the framing material.

It should be understood, of course, that the foregoing relates to exemplary embodiments of the invention and that modifications may be made without departing from the spirit and scope of the invention as set forth in the following claims.

What is claimed is:

1. A tool comprising:
a triangular piece having a first side forming a right angle with a second side;
an alignment edge protruding orthogonally from the second side of the triangular piece,
wherein the first side and the second side have a length of 3.5 inches.

2. The tool of claim 1, wherein a slot is cut in the triangular piece, the slot running parallel to a hypotenuse of the triangular piece.

3. The tool of claim 1, further comprising a triangular cut out in the triangular piece.

4. A tool comprising:
a triangular piece having a first side forming a right angle with a second side;
an alignment edge protruding orthogonally from the second side of the triangular piece,
wherein the first side and the second side have a length of 5.5 inches.

5. The tool of claim 4, wherein a slot is cut in the triangular piece, the slot running parallel to a hypotenuse of the triangular piece.

6. The tool of claim 4, further comprising a triangular cut out in the triangular piece.

7. A tool comprising:
a triangular piece having a first side forming a right angle with a second side;
an alignment edge protruding orthogonally from the second side of the triangular piece,
wherein the first side and the second side have a length of 1.5 inches.

8. The tool of claim 7, wherein a slot is cut in the triangular piece, the slot running parallel to a hypotenuse of the triangular piece.

9. The tool of claim 7, further comprising a triangular cut out in the triangular piece.

10. The tool of claim 7, further comprising a hole cut into the triangular piece of the tool.
